(19) United States
(12) Patent Application Publication
(10) Pub. No.: US 2024/0287421 A1
(43) Pub. Date: Aug. 29, 2024

(54) Composition

(71) Applicant: GIVAUDAN SA, VERNIER (CH)

(72) Inventors: Philippe BLONDEAU, Argenteuil (FR); Deena CHELLAPERMAL, Argenteuil (FR)

(21) Appl. No.: 18/693,120

(22) PCT Filed: Oct. 20, 2022
(86) PCT No.: PCT/EP2022/079167

§ 371 Date: Mar. 18, 2024

(30) Foreign Application Priority Data
Oct. 21, 2021 (GB) 2115101.4

(51) Int. Cl. C11D 3/50; C11D 1/00; C11D 3/04; C11D 3/22; C11D 3/38

(52) U.S. Cl. CPC C11D 3/505; C11D 1/008; C11D 3/046; C11D 3/222; C11D 3/227; C11D 3/38

(57) ABSTRACT

The present invention relates to the field of laundry care, more particularly to a liquid laundry care composition, to a method for obtaining a liquid laundry care composition, and to the use of liquid laundry care compositions to provide an enhanced fragrance perception on fabrics.

The present invention relates to the field of laundry care compositions, more particularly to a liquid laundry care composition, to a method for obtaining a liquid laundry care composition, and to the use of liquid laundry care compositions to provide an enhanced fragrance perception on fabrics.

Laundry care compositions constitute a category of consumer products, the main function of which is to deliver a fragrance at some point of time in an application. Examples of laundry care compositions include scent boosters and fabric refreshers. These laundry care compositions are available in either solid or liquid forms.

Typically, a solid scent booster is added directly to a wash machine prior to starting a wash cycle. Such a scent booster aims at providing an enhanced perception of the fragrance by the consumer throughout the wash and rinse cycles, at the moment the laundry is taken out of the machine, during drying and after the laundry has been dried. Conversely, a liquid scent booster is typically added after the wash cycle has been completed.

Fabric refreshers are generally sprayed onto fabrics and aim at providing an enhanced perception of fragrance by the consumer immediately after spraying, as well as after a period of time after spraying.

Such a release profile is achieved by combining free, non-encapsulated fragrance components together with encapsulated fragrance components, wherein the free fragrance components contribute essentially to enhancing fragrance perception on wet fabrics, while the encapsulated components contribute essentially to enhancing fragrance perception on dry fabrics. Additionally, the encapsulated components may be released during fabric handling, typically under the action of mechanical forces. Core-shell microcapsules are preferably used, wherein the core comprises the encapsulated fragrance components and is surrounded by an impervious, frangible shell.

Both the free fragrance components and the encapsulated fragrance components are dispersed in the laundry care composition, in solid or liquid forms.

WO 2018/073238 A1 discloses a ringing gel containing an aqueous phase, a surfactant system essentially consisting of non-ionic surfactant(s), a linker and an oil phase comprising a hydrophobic active ingredient and/or microcapsules. This system does not comprise any ionic surfactants, that would be susceptible to interact unfavourably with the consumer product formulation when they are included therein. Similarly, this system does not comprise any cationic microcapsule deposition-enhancing polymer.

Therefore, it may be desirable to provide laundry care compositions that comprise ingredients that enhance the deposition of microcapsules onto the substrates. Such laundry care compositions may comprise both free and encapsulated fragrance components, which are compatible with a broad range of consumer products, particularly with detergents, more particularly with laundry care detergents.

Consumers are increasingly concerned about using materials obtained from non-renewable sources, such as synthetic petrochemicals, as well as about the processes for manufacturing the consumer products. The “clean label” concept is one of the biggest trends of the decade. The term itself has many definitions including sustainable, naturally sourced and biodegradable ingredients as well as minimal processing and impact on the environment. Nevertheless, it is generally difficult to use natural materials or materials derived from nature to satisfy the requirements for suitable encapsulation compositions. Bio-based and biodegradable ingredients for customer formulations must provide a unique combination of performance and sustainability, so consumers feel confident in the safety and efficacy of these ingredients.

Moreover, it may be desirable to provide laundry care compositions that comprise renewable, especially bio-sourced ingredients. It is also desirable to provide laundry care compositions that are biodegradable.

### SUMMARY OF THE INVENTION

In a first aspect, the present invention provides a liquid laundry care composition comprising:
a) at least one non-encapsulated fragrance ingredient;
b) at least one core-shell microcapsule, wherein the at least one core-shell microcapsule comprises a core containing at least one encapsulated fragrance ingredient and a shell surrounding the core;
c) at least one surfactant;
d) a suspending agent comprising at least one polysaccharide;
e) optionally, a cationic deposition agent; and, optionally
f) an electrolyte.

In a further aspect, the invention provides methods of preparing the laundry care composition as described herein.

The invention further provides use of the laundry care composition as described herein.

### Definitions

In the context of the present invention, a “biodegradable ingredient” is an ingredient which meets the pass criteria for “inherently biodegradable” and/or “readily biodegradable” in at least one OECD biodegradation study. In order to avoid any ambiguity, this means that if an ingredient passes one test but fails one or more other ones, the pass result overrules the other test results.

“Ultimate biodegradability” refers to the complete breakdown of a chemical into water, carbon dioxide and new biomass.

For assessment of the pass criteria for “readily biodegradable”, the biodegradation study can be carried out using standardised methods such as OECD Method 301C, OECD Method 301D, OECD Method 301F and OECD Method 310. These methods are suitable for volatile materials.

OECD Method 301C, OECD Method 301D and OECD Method 301F are described in the OECD Guidelines for the Testing of Chemicals, Section 3, Test No. 301: Ready Biodegradability (Adopted: 17 Jul. 1992; https://doi.org/10.1787/9789264070349-en).

OECD Method 310 is described in the OECD Guidelines for the Testing of Chemicals, Section 3, Test No. 310: Ready Biodegradability—CO2 in sealed vessels (Headspace Test) (Adopted: 23 Mar. 2006; Corrected: 26 Sep. 2014; https://doi.org/10.1787/9789264016316-en).

In the context of the present invention, the pass criteria for “readily biodegradable” are assessed according to OECD Method 301F, which refers to manometric respirometry. In this method the pass level for “ready biodegradability” is to reach 60% of theoretical oxygen demand and/or chemical oxygen demand. This pass value has to be reached in a 10-day window within the 28-day period of the test. The 10-day window begins when the degree of biodegradation has reached 10% of theoretical oxygen demand and/or chemical oxygen demand and must end before day 28 of the test. A preferred way of conducting OECD Method 301F is provided herein below.

Given a positive result in a test of ready biodegradability, it may be assumed that the chemical will undergo rapid and ultimate biodegradation in the environment (Introduction to the OECD Guidelines for the Testing of Chemicals, Section 3, Part 1: Principles and Strategies Related to the Testing of Degradation of Organic Chemicals; Adopted: July 2003).

For assessment of the pass criteria for “inherently biodegradable”, the biodegradation study can be OECD Method 302C, but also OECD Method 301F can be used, although with different pass criteria. Also these methods are suitable for volatile materials.

OECD Method 302C is described in the OECD Guidelines for the Testing of Chemicals, Section 3, Test No. 302C: Inherent Biodegradability: Modified MITI Test (II) (Adopted: 12 May 1981; Corrected 8 Sep. 2009; https://doi.org/10.1787/9789264070400-en).

In the context of the present invention, the pass criteria for “inherently biodegradable” are assessed by OECD Method 302C. In this method the pass level for “inherently biodegradability” is then to reach 70% of theoretical oxygen demand. There is no time limit to reach this level.

Biodegradation rates above 70% may be regarded as evidence of inherent, ultimate biodegradability (OECD Guidelines for the Testing of Chemicals, Section 3, Part 1: Principles and Strategies Related to the Testing of Degradation of Organic Chemicals; Adopted: July 2003).

If OECD Method 301F is used for assessment of the pass criteria for “inherently biodegradable”, the pass level is 60% of theoretical oxygen demand and/or chemical oxygen demand. This pass value can be reached after the 28-day period of the test, which is usually extended to 60 days. No 10-day window applies.

In the present context, if an ingredient is an essential oil, it is considered to be a “biodegradable ingredient” if all of its constituents present at a level≥1 wt.-% fall under the definition of “inherently biodegradable” and/or “readily biodegradable” as defined herein above. However, the essential oil can also be subjected to the above-mentioned biodegradation tests.

In the context of the present invention, a carbon atom in a molecule is defined as “renewable” if one or more of the following conditions are fulfilled:
I. The carbon atom belongs to a molecular moiety originating from nature;
II. The carbon atom belongs to a molecular moiety that has been retrieved from CO₂;
III. The carbon atom belongs to a molecular moiety that has been retrieved from plastic recycling.

The term “bio-sourced” refers to materials intentionally made from substances derived from living (or once-living) organisms (i.e. condition I above is satisfied). The definition includes both natural materials and materials that have undergone some degree of processing.

In the context of the present invention, a “cationic” agent is an agent that either bears a permanent, pH-independent cationic charge, more particularly a quaternized nitrogen group or is cationic at a pH below its isoelectric point.

### DETAILED DESCRIPTION

Preferred and/or optional features of the invention will now be set out. Any aspect of the invention may be combined with any other aspect of the invention unless the context demands otherwise. Any of the preferred or optional features of any aspect may be combined, singly or in combination, with any aspect of the invention, as well as with any other preferred or optional features, unless the context demands otherwise.

### Liquid Laundry Care Composition

The applicant has surprisingly and unexpectedly found that a liquid laundry care composition comprising:
a) at least one non-encapsulated fragrance ingredient;
b) at least one core-shell microcapsule, wherein the at least one core-shell micro-capsule comprises a core containing at least one encapsulated fragrance ingredient and a shell surrounding the core;
c) at least one surfactant;
d) a suspending agent comprising at least one polysaccharide;
e) optionally, a cationic deposition agent; and, optionally
f) an electrolyte.

is capable of enhancing the overall perfume perception on a fabric by enhancing the deposition of both the non-encapsulated perfume and the capsules onto the fabrics. In addition, the liquid laundry care composition is stable and maintains transparency over a broad range of temperatures, overtime.

The invention, therefore, provides a liquid laundry care composition comprising:
a) at least one non-encapsulated fragrance ingredient;
b) at least one core-shell microcapsule, wherein the at least one core-shell micro-capsule comprises a core containing at least one encapsulated fragrance ingredient and a shell surrounding the core;
c) at least one surfactant;
d) a suspending agent comprising at least one polysaccharide;
e) optionally, a cationic deposition agent; and, optionally
f) an electrolyte.

In one embodiment of the present invention, at least 60 wt.-%, preferably at least 80 wt.-%, more preferably at least 90 wt.-% and still more preferably 100 wt.-% of the ingredients a) to e) present in the liquid laundry care composition are biodegradable.

It may be advantageous that the ingredients comprised in the liquid laundry care composition comprise renewable carbon atoms. Therefore, in one embodiment at least 60 wt.-%, preferably at least 80 wt.-%, more preferably at least 90 wt.-% and still more preferably 100 wt.-% of the carbon atoms present in the liquid laundry care composition are renewable.

In one embodiment, at least one of the ingredients c), d) or e) is bio-sourced, optionally wherein at least two of the ingredients c), d) or e) are bio-sourced, optionally wherein all three of the ingredients c), d) or e) are bio-sourced. The enhancement of the overall perfume perception on a fabric by enhancing the deposition of both the non-encapsulated perfume and the capsules onto the fabrics is all the more surprising when most components are bio-sourced. The effect is at least as good as an equivalent formulation that employs surfactant, suspending and, optionally deposition agent that are not bio-sourced.

### Fragrance Ingredient

In one embodiment, at least 60 wt.-%, preferably at least 80 wt.-%, more preferably at least 90 wt.-% and still more preferably 100 wt.-% of the at least one non-encapsulated fragrance ingredient and the at least one encapsulated fragrance ingredient are biodegradable.

The biodegradable fragrance ingredient(s) may be selected from the group consisting of ACETYL ISOEUGENOL ((E)-2-methoxy-4-(prop-1-en-1-yl)phenyl acetate); ADOXAL (2,6,10-trimethylundec-9-enal); AGRUMEX (2-(tert-butyl)cyclohexyl acetate); ALDEHYDE C 10 DECYLIC (decanal); ALDEHYDE C 11 UNDECYLENIC (undec-10-enal); ALDEHYDE C 110 UNDECYLIC (undecanal); ALDEHYDE C 12 LAURIC (dodecanal); ALDEHYDE C 12 MNA (2-methylundecanal); ALDEHYDE C 8 OCTYUC (octanal); CYCLAMEN ALDEHYDE EXTRA (3-(4-isopropylphenyl)-2-methylpropanal); ALDEHYDE ISO C 11 ((E)-undec-9-enal); ALLYL AMYL GLYCOLATE (prop-2-enyl 2-(3-methylbutoxy)acetate); ALLYL CYCLOHEXYL PROPIONATE (prop-2-enyl 3-cyclohexylpropanoate); ALLYL OENANTHATE (prop-2-enyl heptanoate); AMBRETTOLIDE ((Z)-oxacycloheptadec-10-en-2-one); AMBROFIX ((3aR,5aS,9aS,9bR)-3a,6,6,9a-tetramethyl-2,4,5,5a,7,8,9,9b-octahydro-1H-benzo[e][1]benzofuran); AMYL SALICYLATE (pentyl 2-hydroxybenzoate); AUBEPINE PARA CRESOL (4-methoxybenzaldehyde); BENZYL ACETATE (benzyl acetate); BENZYL SALICYLATE (benzyl 2-hydroxybenzoate); BORNYL ACETATE ((2S,4S)-1,7,7-trimethylbicyclo[2.2.1]heptan-2-yl acetate); CARVACROL (5-isopropyl-2-methylphenol); CEDRENE ((1S,8aR)-1,4,4,6-tetramethyl-2,3,3a,4,5,8-hexahydro-1H-5,8a-methanoazulene); CEDRYL ACETATE ((1S,6R,8aR)-1,4,4,6-tetramethyloctahydro-1H-5,8a-methanoazulen-6-yl acetate); CEDRYL METHYL ETHER ((1R,6S,8aS)-6-methoxy-1,4,4,6-tetramethyloctahydro-1H-5,8a-methanoazulene); CITRAL ((E)-3,7-dimethylocta-2,6-dienal); CITRONELLOL (3,7-dimethyloct-6-en-1-ol); CITRONELLYL ACETATE (3,7-dimethyloct-6-en-1-yl acetate); COSMONE ((Z)-3-methylcyclotetradec-5-enone); CRESYL METHYL ETHER PARA (1-methoxy-4-methylbenzene); CYCLOHEXYL ETHYL ACETATE (2-cyclohexylethyl acetate); CYCLOHEXYL SALICYLATE (cyclohexyl 2-hydroxybenzoate); DAMASCENONE ((E)-1-(2,6,6-trimethylcyclohexa-1,3-dien-1-yl)but-2-en-1-one); DAMASCONE ALPHA ((E)-1-(2,6,6-trimethylcyclohex-2-en-1-yl)but-2-en-1-one); DECALACTONE GAMMA (5-hexyloxolan-2-one); DECENAL-4-TRANS ((E)-dec-4-enal); DIHYDRO MYRCENOL (2,6-dimethyloct-7-en-2-ol); DIPHENYL OXIDE (oxydibenzene); DIHYDRO ANETHOLE (1-methoxy-4-propylbenzene); DIHYDRO JASMONE (3-methyl-2-pentylcyclopent-2-enone); DIMETHYLANTHRANILATE (methyl 2-(methylamino)benzoate); DIMETHYL BENZYL CARBINYL ACETATE (2-methyl-1-phenylpropan-2-yl acetate); DIMETHYL BENZYL CARBINYL BUTYRATE (2-methyl-1-phenylpropan-2-yl butanoate); DIMETOL (2,6-dimethylheptan-2-ol); DODECALACTONE DELTA (6-heptyltetrahydro-2H-pyran-2-one); DODECALACTONE GAMMA (5-octyloxolan-2-one); DODECENAL ((E)-dodec-2-enal); EBANOL ((E)-3-methyl-5-(2,2,3-trimethylcyclopent-3-en-1-yl)pent-4-en-2-ol); ETHYL HEXANOATE (ethyl hexanoate); ETHYL METHYL-2-BUTYRATE (ethyl 2-methyl butyrate); ETHYL MALTOL (2-ethyl-3-hydroxy-4H-pyran-4-one); ETHYL OENANTHATE (ethyl heptanoate); ETHYL VANILLIN (3-ethoxy-4-hydroxybenzaldehyde); ETHYLENE BRASSYLATE (1,4-dioxacycloheptadecane-5,17-dione); EUCALYPTOL ((1s,4s)-1,3,3-trimethyl-2-oxabicyclo[2.2.2]octane); EUGENOL (4-allyl-2-methoxyphenol); EVERNYL (methyl 2,4-dihydroxy-3,6-dimethylbenzoate); FIXAMBRENE (3a,6,6,9a-tetramethyldodecahydronaphtho[2,1-b]furan); FLORHYDRAL (3-(3-isopropylphenyl)butanal); FLORIDILE ((E)-undec-9-enenitrile); GALBANONE PURE (1-(5,5-dimethylcyclohex-1-en-1-yl)pent-4-en-1-one); GARDENOL (1-phenylethyl acetate); GERANIOL ((E)-3,7-dimethylocta-2,6-dien-1-ol); GERANYL ACETATE ((E)-3,7-dimethylocta-2,6-dien-1-yl acetate); HABANOLIDE ((E)-oxacyclohexadec-12-en-2-one); HEDIONE (methyl 3-oxo-2-pentylcyclopentaneacetate); HEXENAL-2-TRANS ((E)-hex-2-enal); HEXENOL-3-CIS ((Z)-hex-3-en-1-ol); HEXENYL-3-CIS ACETATE ((Z)-hex-3-en-1-yl acetate); HEXENYL-3-CIS SALICYLATE ((Z)-hex-3-en-1-yl 2-hydroxybenzoate); HEXYL ACETATE (hexyl acetate); INDOLENE (8,8-di(1H-indol-3-yl)-2,6-dimethyloctan-2-ol); IONONE BETA ((E)-4-(2,6,6-trimethylcyclohex-1-en-1-yl)but-3-en-2-one); IRISANTHEME ((E)-3-methyl-4-(2,6,6-trimethylcyclohex-2-en-1-yl)but-3-en-2-one); IRISONE ALPHA ((E)-4-(2,6,6-trimethylcyclohex-2-en-1-yl)but-3-en-2-one); ISOAMYL ACETATE (3-methylbutyl acetate); ISOAMYL BUTYRATE (3-methylbutyl butanoate); ISOEUGENOL ((E)-2-methoxy-4-(prop-1-en-1-yl)phenol); ISOJASMONE B 11 (2-hexylcyclopent-2-en-1-one); ISORALDEINE ((E)-3-methyl-4-(2,6,6-trimethylcyclohex-2-en-1-yl)but-3-en-2-one); JASMONYL (3-butyl-5-methyltetrahydro-2H-pyran-4-yl acetate); LAITONE (8-isopropyl-1-oxaspiro[4.5]decan-2-one); LEMONILE ((2E,6Z)-3,7-dimethylnona-2,6-dienenitrile); LINALOOL (3,7-dimethylocta-1,6-dien-3-ol); LINALOOL OXIDE (2-(5-methyl-5-vinyltetrahydrofuran-2-yl)propan-2-ol); LINALYL ACETATE (3,7-dimethylocta-1,6-dien-3-yl acetate); MANZANATE (ethyl 2-methylpentanoate); MAYOL ((4-isopropylcyclohexyl)methanol); MEFROSOL (3-methyl-5-phenylpentan-1-ol); MELONAL (2,6-dimethylhept-5-enal); MERCAPTO-8-METHANE-3-ONE (mercapto-para-menthan-3-one); METHYLANTHRANILATE (methyl 2-aminobenzoate); METHYL BENZOATE (methyl benzoate); METHYL DIANTILIS (2-ethoxy-4-(methoxymethyl)phenol); METHYL HEPTENONE PURE (6-methylhept-5-en-2-one); METHYL LAITONE (8-methyl-1-oxaspiro[4.5]decan-2-one); METHYL OCTYNE CARBONATE (methyl non-2-ynoate); METHYL SALICYLATE (methyl 2-hydroxybenzoate); NECTARYL (2-(2-(4-methylcyclohex-3-en-1-yl)propyl)cyclopentanone); NEOFOLIONE ((E)-methyl non-2-enoate); NEROLEX ((2Z)-3,7-dimethylocta-2,6-dien-1-ol); NEROLIDOL ((Z)-3,7,11-trimethyldodeca-1,6,10-trien-3-ol); NEROLINE CRYSTALS (2-ethoxynaphthalene); NEROLIONE (1-(3-methylbenzofuran-2-yl)ethanone); NERYL ACETATE ((Z)-3,7-dimethylocta-2,6-dien-1-yl acetate); NONADIENAL ((2E,6Z)-nona-2,6-dienal); NONENAL-6-CIS ((Z)-non-6-enal); NONENOL-6-CIS ((Z)-non-6-en-1-ol); NYMPHEAL (3-(4-(2-methylpropyl)-2-methylphenyl)propanal); OCTALACTONE DELTA (6-propyltetrahydro-2H-pyran-2-one); ORANGER CRYSTALS (1-(2-naphtalenyl)-ethanone); PARA TERT BUTYL CYCLOHEXYL ACETATE (4-(tert-butyl)cyclohexyl acetate); PEACH PURE (5-heptyldihydrofuran-2(3H)-one); PELARGOL (3,7-dimethyloctan-1-ol); PHENYL ETHYL ACETATE (2-phenylethyl acetate); PINENE ALPHA (2,6,6-trimethylbicyclo[3.1.1]hept-2-ene); PINENE BETA (6,6-dimethyl-2-methylenebicyclo[3.1.1]heptane); POMAROSE ((2E,5E)-5,6,7-trimethylocta-2,5-dien-4-one); POMELOL FF (2,4,7-Trimethyl-6-octen-1-ol); PRENYL ACETATE (3-methylbut-2-en-1-yl acetate); PRUNOLIDE (5-pentyldihydrofuran-2(3H)-one); RASPBERRY KETONE (4-(4-hydroxyphenyl)butan-2-one); ROSALVA (dec-9-en-1-ol); ROSE OXIDE CO (4-methyl-2-(2-methylprop-1-en-1-yl)tetrahydro-2H-pyran); ROSYRANE SUPER (4-methyl-2-phenyl-3,6-dihydro-2H-pyran); SAFRANAL (2,6,6-trimethylcyclohexa-1,3-dienecarbaldehyde); SCENTAURUS JUICY (4-(dodecylthio)-4-methylpentan-2-one); SILVIAL (2-methyl-3-[4-(2-methylpropyl)phenyl]-propanal); STYRALLYL ACETATE (1-phenylethyl acetate); SYLKOLIDE ((E)-2-((3,5-dimethylhex-3-en-2-yl)oxy)-2-methylpropyl cyclopropanecarboxylate); TERPINENE GAMMA (1-methyl-4-propan-2-ylcyclohexa-1,4-diene); TERPINEOL (2-(4-methylcyclohex-3-en-1-yl)propan-2-ol); TERPINOLENE (1-methyl-4-(propan-2-ylidene)cyclohex-1-ene); TETRAHYDRO UNALOOL (3,7-dimethyloctan-3-ol); TOSCANOL (1-(cyclopropylmethyl)-4-methoxybenzene); TRIDECENE-2-NITRILE ((E)-tridec-2-enenitrile); TRIFERNAL (3-phenylbutanal); TROPIONAL (3-(benzo[d][1,3]dioxol-5-yl)-2-methylpropanal); UNDECAVERTOL ((E)-4-methyldec-3-en-5-ol); YARA YARA (2-methoxynaphtalene); BOIS CEDRE ESS CHINE (cedar wood oil); EUCALYPTUS GLOBULUS ESS CHINA (eucalyptus oil); GALBANUM ESS (galbanum oil); GIROFLE FEUILLES ESS RECT MADAGASCAR (clove oil); LAVANDIN GROSSO OIL FRANCE ORPUR (lavandin oil); MANDARIN OIL WASHED COSMOS (mandarin oil); ORANGE TERPENES (orange terpenes); PATCHOULI ESS INDONESIE (patchouli oil); and YLANG ECO ESSENCE (ylang oil).

The above-mentioned ingredients have all been identified as not only fulfilling at least one of the aforementioned biodegradability criteria, but also as being suitable for application in consumer products, more particularly in laundry care products. They are also suitable in encapsulation with respect to their physical and chemical properties, such as lipophilicity, molecular size and reactivity towards shell materials. They therefore provide a useful selection of fragrance ingredients for readily and reliably providing more sustainable fragrance encapsulates.

### Core-Shell Microcapsules

Core-shell microcapsules are frequently used in consumer products, such as household care, personal care and fabric care products. Functional materials include for example fragrances, cosmetic actives, and biologically active ingredients, such as biocides and drugs. These microcapsules are particularly suitable for delivery of fragrances onto substrates, such as skin, hair, fabrics or hard household surfaces. They can also act as a means of controlling the spatio-temporal release of the fragrance. The core-shell microcapsules comprise a core comprising the fragrance and the shell is impervious or partially impervious to the encapsulated fragrance.

In one embodiment, the shell of the core-shell microcapsule is biodegradable. Such biodegradable shells typically comprise biodegradable polymers, more particularly biodegradable bio-sourced polymers, such as native or modified polysaccharides, and native, modified or denatured proteins.

The core-shell microcapsules are typically provided in the form of suspension of microcapsules in water, herein referred to as “slurries”. The amount of microcapsules (solid content) in these slurries is typically between 30 and 50 wt.-%, more particularly between 35 and 45 wt.-%. The amount of microcapsules mentioned herein refers to the amount of dry microcapsules contained in such slurries.

In the liquid laundry care composition according to the present invention, the core-shell microcapsules are dispersed in a composition comprising all the other ingredients a), c), d) and optionally e) and/or f). The level of microcapsules is from 0.4 wt.-% to 2 wt.-%, preferably from 0.6 wt.-% to 1.2 wt.-%, based on the total weight of the composition. At lower levels, the effect of the microcapsules may not be perceivable by the consumer, while at higher levels, the microcapsules may increase the turbidity of the composition.

### Surfactant

The liquid laundry care composition according to the invention comprises at least one surfactant. The main function of the surfactant is to solubilize the non-encapsulated fragrance.

In one embodiment, the at least one surfactant is selected from the group consisting of ethoxylated fatty acid triglycerides, more particularly ethoxylated castor oil, optionally hydrogenated castor oil; alkyl alcohol ethoxylate, alkyl polyglycerides, glycolipids, sugar amide surfactants, polyglyceryl fatty acid esters, amino acid esters, amino acid amides, alkyl glucoside and alkyl polyglucosides, sorbitan fatty ester alkylglucoside crosspolymers, and combinations thereof. In one embodiment, the at least one surfactant may be selected from the group consisting of polyglyceryl fatty acid esters, ethoxylated hydrogenated castor oil, alkyl alcohol ethoxylate, sorbitan fatty ester alkylglucoside crosspolymers, lauryl glucoside, polyglyceryl-2 dipolyhydroxystearate and combinations thereof.

In one embodiment, the at least one surfactant is Eumulgin VL75 (ex BASF, a blend composed of Lauryl Glucoside, Polyglyceryl-2 Dipolyhydroxystearate and Glycerin).

In one embodiment, the at least on surfactant is selected from the group consisting of Tego solve VE55 (Polyglyceryl-3 Caprylate/Caprate/Succinate; Propylene Glycol); Tego solve VE 90 (Polyglyceryl-6 Caprylate (and) Polyglyceryl-4 Caprate); Tego soft PC 41 (Polyglyceryl-4 Caprate, Polyglyceryl-4 Caprate); Tego solve 61 (Polyglyceryl-6 Caprylate, Polyglyceryl-3 Cocoate, Polyglyceryl-4 Caprate and Polyglyceryl-6 Ricinoleate) (all ex Evonik) and combinations thereof.

In one embodiment, suitable solubilisation of non-encapsulated fragrance in the composition may be achieved with surfactants having a Hydrophobic Lypophilic Balance (HLB) of from 10 to 20, optionally from 12 to 18. For example, suitable solubilisation may be achieved with ethoxylated fatty acid triglycerides having a HLB larger than 13, such as poly(ethylene oxide) hydrogenated castor oil, for example Eumulgin CO 40 (ex BASF), alkyl alcohol ethoxylate, for example Neodol 91/8 (ex Shell), sorbitan oleate decylglucoside crosspolymer or combinations thereof.

Typically, ethoxylated castor oil is obtained by transesterification of castor oil which results in an ethoxylated triglyceride, wherein the ethylene oxide moieties are inserted between the glycerol residue and the fatty acid moieties. In one embodiment, the ethoxylated castor oil is ethoxylated hydrogenated castor oil.

In one embodiment, the surfactant is bio-sourced. The advantage of bio-sourced surfactants is that they are derived from renewable resources.

In one embodiment, the at least one surfactant is selected form the group consisting of bio-sourced ethoxylated hydrogenated castor oil and bio-sourced sorbitan fatty ester alkylglucoside crosspolymers.

In the case bio-sourced ethoxylated fatty acid triglycerides are employed, ethoxylated fatty acid triglyceride surfactants formed by employing 100% bio-sourced ethylene oxide are especially preferred.

More particularly, ethoxylated hydrogenated castor oil comprising 40 bio-sourced ethylene oxide units is particularly preferred.

In one embodiment, suitable solubilization may be achieved by combining surfactants having different HLB values, for example by combining a first grade of sorbitan oleate decylglucoside crosspolymer having a HLB value of from 12 to 14 and a second grade of sorbitan oleate decylglucoside crosspolymer having a HLB value of from 8 to 10.

In one embodiment, the surfactant is biodegradable.

In one embodiment, the amount of non-encapsulated fragrance that can be solubilized in the composition is from 1 wt.-% to 4 wt.-%, more particularly from 1.5 wt.-% to 3.5 wt.-%. At lower levels, the impact of the non-encapsulated fragrance may be too weak, while at higher levels, solubilizing the fragrance may require a too large amount of surfactants. Ideally, the surfactant to non-encapsulated fragrance ratio is from 1.5 to 3.5.

### Suspending Agent

The liquid laundry care composition comprises at least one polysaccharide as suspending agent.

In one embodiment, the suspending agent comprising a polysaccharide is biodegradable.

In one embodiment, the suspending agent comprising a polysaccharide is bio-sourced.

The applicant has found that polysaccharides obtained from a fermentation process were particularly suitable as suspending agents in the context of the present invention. Such polysaccharides include bacterial derived cellulose, diutan gum and combinations thereof. Besides their excellent suspending power, the advantage of such suspending agents is that they are not only fully bio-sourced, but also biodegradable.

The amount of suspending agent in the composition is from 0.005 wt.-% to 1 wt.-%, preferably from 0.05 wt.-% to 0.5 wt.-%. This amount refers to the suspending agent in dry format. The bacterial derived cellulose may usually be supplied in the form of a slurry in water, this slurry containing from 0.01 to 10 wt.-% of cellulose.

Wood derived cellulose, such as micro-fibrillated cellulose may also be used.

### Cationic Deposition Agents

Cationic deposition agents that are suitable in the context of the present invention include cationic polymers or polymers that are cationic at a pH below their isoelectric point.

In one embodiment, the cationic deposition agent is biodegradable.

In one embodiment, the cationic deposition agent is bio-sourced. Such cationic deposition agents include cationic guar gums, proteins, choline chloride and chitosan.

The cationic guar gums may vary in terms of molecular weight, electrical charge, and nature of substitution. Common substituents include hydroxypropyltrimonium chloride and hydroxypropyl groups. Preferably, the cationic guar gum has a degree of substitution of 8% or less, such as Jaguar C-500 STD, ex Solvay. Compared to cationic guar gum grades having higher degree of substitution, Jaguar C-500 STD provides stable compositions according to the invention, is inherently biodegradable and contains 92% of renewable carbon.

Proteins are very versatile polyampholites, owing to their chemical and conformational diversity, hydrophilic to hydrophilic balance and electrostatic properties. Proteins that are suitable in the context of the present invention include gelatine, whey proteins, and protein originating form a vegan source, such as soy proteins, pea proteins, rice proteins, cotton proteins and hemp proteins. These proteins may be used as such or in denatured form. Protein denaturation usually involves changes in the secondary, tertiary and quaternary structure of the protein, transforming a highly functional and specialized macromolecule into a material that can be employed in a broad range of applications. It is well known that denaturation may be induced by the action of, for example, temperature, pH, ionizing radiation, shear stresses, water structure destroying agents and detergents. The proteins may be isolated from the vegan source by known processes, such as extraction and centrifugation.

Choline chloride is a low molecular weight quaternary ammonium salt that has also shown surprisingly an enhancing effect on microcapsule deposition.

Chitosan is a biopolymer derived from chitin, forming the exoskeleton of crustaceans and preserving the shape of various fungi, such as Ascomycetes, Zygomycetes, Basidiomycetes and Deuteromycetes, for example Absidia, Mucor, Aspergillus niger, Ganoderma lucidum, Rhizopus oryzae, and the like. Chitosan production involves the alkaline or enzymatic deacetylation of chitin and is characterized by a deacetylation grade. Both low deacetylation grades, typically below 80% deacetylation, and high deacetylation grades, typically higher than or equal to 80% deacetylation exist. Deacetylated chitosan is a copolymer consisting of N-acetyl-D-glucosamine a D-glucosamine moieties. The deacetylation grade may be determined by 1H and/or 13C nuclear magnetic resonance spectroscopy. Chitosan with a deacetylation grade between 60% and 100%, more particularly between 70% and 90%, still more particularly between 75% and 85%, has the advantage of being more soluble. Chitosan is available with molecular weights typically ranging from 3,000 to 5,000,000 g/mol. The molecular weight may be determined by viscosity measurement and/or gel permeation chromatography, according to methods known in the art.

### Electrolyte

The liquid laundry care composition optionally contains an electrolyte. The role of the electrolyte is to minimize the electrostatic interactions between the negatively charged polyelectrolytes, in particular diutan gum, and the positively charged species, in particular the cationic guar gum and positively charged proteins and chitosan.

An additional role of the electrolyte may be to screen the negative charges of the microcapsules, thereby increasing the deposition capability of the microcapsules.

Suitable electrolytes include water-soluble inorganic and organic salts. Inorganic salts of monovalent alkaline metals, such as sodium chloride, potassium chloride, and lithium chloride are preferred over those of multivalent metal salts that may form insoluble complexes with the negatively charged polyelectrolytes.

Choline chloride may be considered as both a deposition agent, as mentioned hereinabove, and as an electrolyte. In one embodiment, the liquid laundry care composition comprises an electrolyte selected from monovalent metal salts, such as sodium chloride, choline chloride and combinations thereof.

### Functional Ingredients

The liquid laundry care compositions according to the invention may further comprise functional ingredients, such as optical brighteners, biocides, pest repellents, bacteriostatic agents, enzymes and bentonites. More particularly, the enzyme may be a cellulase. Such functional agents may be present in an amount of from 0.01 wt.-% to 5 wt.-%, depending on the nature of the functional ingredients.

In one embodiment, the functional ingredient is an enzyme, such as a cellulase, for example an endo-1,4-β-D-glucanase.

In one embodiment, the liquid laundry care composition comprises:
a) From 0.5 to 4 wt.-%, preferably from 1.0 to 3.5 wt.-% of at least one non-encapsulated perfume ingredient;
b) From 0.2 to 2 wt.-%, preferably from 0.3 to 1.2 wt.-% of the at least one core-shell microcapsule;
c) From 2.5 to 12 wt.-%, preferably from 3 to 10 wt.-% of the at least one surfactant.
d) From 0.05 to 6 wt.-%, preferably from 0.1 to 5 wt.-% of the at least one suspending agent comprising at least one polysaccharide; optionally wherein the at least one polysaccharide is obtained from a fermentation process;
e) Optionally, from 0.0005 to 2 wt-%, preferably from 0.0008 to 1.0 wt.-% of a cationic deposition agent; and, optionally
f) From 0.1 to 5 wt.-%, preferably from 0.5 to 2.5 wt.-% of an electrolyte; and, optionally
g) from 0.01 wt.-% to 5 wt.-% of one or more functional ingredients.

Among the range of compositions that may be obtained by combining the ingredients mentioned hereinabove within the prescribed ranges, some combinations are particularly preferred because of their superior stability and olfactive performance.

In one embodiment of the present invention, the liquid laundry care composition comprises:
a) From 0.5 to 4 wt.-%, preferably from 1.0 to 3.5 wt.-% of at least one non-encapsulated perfume ingredient;
b) From 0.2 to 2 wt.-%, preferably from 0.3 to 1.2 wt.-% of at least one core-shell microcapsule;
c) From 2.5 to 8 wt.-%, preferably from 3 to 6 wt.-% of ethoxylated hydrogenated castor oil, optionally bio-sourced ethoxylated hydrogenated castor oil;
d) From 0.05 to 6 wt.-%, preferably from 0.1 to 5 wt.-% of bacterial derived cellulose, diutan gum or combinations thereof;
e) Optionally, from 0.0005 to 0.1 wt-%, preferably from 0.0008 to 0.002 wt.-% of chitosan; and
f) From 0.0 to 2.5 wt.-% of an electrolyte, preferably sodium chloride, choline chloride, or a mixture thereof.

In respect to item e), it is particularly advantageous that the chitosan has a molecular weight between 500,000 and 5,000,000 g/mol, more particularly between 1,000,000 and 4,000,000 g/mol, still more particularly between 1,500,000 and 3,000,000 g/mol. Such chitosan provides the best stability and olfactive performance when employed in the compositions comprising ethoxylated hydrogenated castor oil.

In one embodiment of the present invention, the liquid laundry care composition comprises:
a) From 0.5 to 4 wt.-%, preferably from 1.0 to 3.5 wt.-% of at least one non-encapsulated perfume ingredient;
b) From 0.2 to 2 wt.-%, preferably from 0.3 to 1.2 wt.-% of at least one core-shell microcapsule;
c) From 2.5 to 8 wt.-%, preferably from 3 to 6 wt.-% of ethoxylated hydrogenated castor oil, optionally bio-sourced ethoxylated hydrogenated castor oil;
d) From 0.05 to 6 wt.-%, preferably from 0.1 to 5 wt.-% of bacterial derived cellulose, diutan gum and combinations thereof;
e) Optionally, from 0.2 to 2 wt-%, preferably from 0.4 to 1.2 wt.-% of a protein; and
f) From 0.0 to 2.5 wt.-% of an electrolyte, preferably sodium chloride, choline chloride, or a mixture thereof.

In one embodiment of the present invention, the liquid laundry care composition comprises:
a) From 0.5 to 4 wt.-%, preferably from 1.0 to 3.5 wt.-% of at least one non-encapsulated perfume ingredient;
b) From 0.2 to 2 wt.-%, preferably from 0.3 to 1.2 wt.-% of at least one core-shell microcapsule;
c) From 4 to 12 wt.-%, preferably from 8 to 10 wt.-% of sorbitan oleate decylglucoside crosspolymer having a HLB value of from 12 to 14;
d) From 0.05 to 1 wt.-%, preferably from 0.1 to 0.5 wt.-% of diutan gum;
e) From 0.0005 to 0.1 wt-%, preferably from 0.0008 to 0.002 wt.-% of chitosan; and
f) From 0.1 to 5 wt.-%, preferably from 0.5 to 2.5 wt.-% of an electrolyte, preferably sodium chloride, choline chloride, or a mixture thereof.

In respect to item e), it is particularly advantageous that the chitosan has a molecular weight between 3,000 and 1,000,000 g/mol, more particularly between 10,000 and 500,000 g/mol, still more particularly between 30,000 and 300,000 g/mol. Such chitosan provides the best stability and olfactive performance when employed in the compositions comprising sorbitan oleate decylglucoside crosspolymer.

In one embodiment, the liquid laundry care composition is a liquid scent booster.

In one embodiment, the liquid laundry care composition is a fabric refresher.

### Method

In a second aspect, the present invention provides a method for obtaining a composition according to the present invention, the method comprising the step of emulsifying the at least one non-encapsulated fragrance ingredient and a composition comprising the at least one surfactant, the at least one suspending agent, the at least one core-shell microcapsule, optionally the at least one cationic deposition agent, and, optionally, the electrolyte.

The non-encapsulated fragrance/perfume ingredient, surfactant, suspending agent, core-shell microcapsules, cationic deposition agent and the electrolyte are as described hereinabove.

The dissolution of the ingredients and the emulsification step are preferably performed at room temperature.

In order to solubilize chitosan, the pH of the aqueous phase may be lowered to a value of from pH=3.5 to pH=5, for example with acetic acid or citric acid.

Preferably, the suspending agent comprising at least one polysaccharide, such as the bacterial derived cellulose, the diutan gum or combinations thereof, are dispersed in water, thereby forming an aqueous phase, by using a blade operating at 1000-1700 rpm and then let to hydrate for 24 hours.

If necessary, the emulsification step may be performed by applying high shear mixing, for example by using a propeller, a blade, a blender, a mixer, a stirrer or a rotor-stator mixer operating at a speed of from 3000 rpm to 20000 rpm, or a high pressure homogeniser.

In one embodiment, the pH of the liquid laundry care composition is from 3 to 7, more particularly from 3.5 to 6.

### Use

In a third aspect, the present invention provides the use of compositions according to the present invention to enhance the fragrance perception on fabrics.

In one embodiment, the liquid laundry care composition is a scent booster and may be used by pouring it into the softener compartment of a laundry wash machine, so that the composition is delivered to the fabric load after the wash cycle has been completed.

In one embodiment, the weight ratio of the liquid scent booster composition to fabric load is from 0.002 to 0.1, preferably from 0.01 to 0.08.

In one embodiment, the laundry care composition is a laundry refresher and may be sprayed on clothing.

Further features and particular advantages of the present invention become apparent from the following examples.

### EXAMPLES

### Example 1—Formulation of Liquid Scent Boosters

In this example a series of samples were prepared by emulsifying the free perfume oil in a composition comprising the water-soluble or water-dispersible components that included the surfactants, the suspending agents, the cationic deposition agents and the microcapsule slurry.

The stability of the resulting formulation was assessed visually and by using a Turbiscan AGS. The Turbiscan measures the colloidal stability of a liquid system filled in a vertical tube by measuring the intensity of both the transmitted and the backscattered light from this liquid system. These intensities allow direct monitoring of local physical heterogeneities with a vertical resolution down to 20 μm. Destabilization phenomena (sedimentation or creaming layers, aggregates, agglomerates or coalescence) are detected and monitored over time at different intervals. Such phenomena induce slight variations of the turbidity of the system along the vertical axis. The colloidal stability is given by the Turbiscan Stability Index (TSI): the lowest this index, the highest the colloidal stability is. A full description of how this index is calculated may be found under https/www.formulaction.com/en/knowledge-center/turbiscan-stability-index. The thermal stability was assessed by visual inspection after 1 month storage at 45° C.

In the context of the present invention, systems having a TSI value of less than 5 were considered as stable with respect to phase separation.

### 1.1. Liquid Scent Booster Comprising a Mixture of Ethoxylated Alkyl Alcohol and Ethoxylated Hydrogenated Castor Oil as a Surfactant and a Polyampholyte as a Cationic Deposition Agent

The reference formulation is Example 1, comprising a mixture of ethoxylated hydrogenated castor oil (Eumulgin C040, ex BASF) and ethoxylated alkyl alcohol (Neodol 91/8, ex Shell) at a ratio of 3/2.5 and a polyampholyte (Flosoft FS 222, ex SNF), as well as microcapsules having an aminoplast shell, obtained by applying the method described in Example 1 of WO 2016/207180.

This formulation shows excellent performances in terms of stability and perfume perception but employs two non-bio-sourced ingredients (Neodol 91/8 and Flosoft FS 222) as well as aminoplast microcapsules.

### 1.2. Liquid Scent Booster Employing a Higher Number of Bio-Sourced Ingredients

The following examples illustrate compositions according to the present invention employing a higher number of bio-sourced ingredients than the composition of Example 1.1.

The compositions were obtained as follows:

A 0.5 wt.-% of a suspending agent solution was prepared by dissolving chitosan or Jaguar C 50 (cationic guar gum, ex Solvay) in an aqueous phase, the pH of which has been previously adjusted at a value of 3.7±0.3, in order to form Solution A1.

A known amount of liquid bacterial derived cellulose Cellulon or of diutan gum, according to Table 1, was dispersed in about 60 g of water under 1000 to 1700 rpm stirring with a blade during 15 minutes and the solution was let 24 hours in order to complete the hydration of the polymer and form Solution B.

A known amount of surfactant and known amount of free, non-encapsulated perfume oil, according to Table 1, was added to Solution B under stirring with a propeller at a speed of 100 rpm.

Solution A1, Jaguar C 500 (cationic guar gum, ex Solvay) or the protein (Coltide, ex Croda) was added to the above mixture, while maintaining the stirring speed at 100 rpm, in order to provide a known amount of deposition polymer in the composition.

The stirring speed was reduced to 40 rpm and a known amount of microcapsule slurry containing a known amount of polysaccharide-based microcapsules was added to the above mixture, while maintaining the stirring speed at 100 rpm, in order to provide a known amount of microcapsules in the composition.

A series of stable formulations were prepared which are reported in Table 1.

TABLE 1
Liquid scent booster formulations

| Sample # | 1 | 2 | 3 | 4 | 5 | 6 | 7 | 8 | 9 |
|---|---|---|---|---|---|---|---|---|---|
| Free perfume oil | 3 | 3 | 3 | 3 | 3 | 3 | 3 | 3 | 3 |
| Surfactant | | | | | | | | | |
| Bio-sourced PEG-40- | | | | | 5 | 5 | 5 | 5 | 5 |
| hydrogenated castor oil | | | | | | | | | |
| Eumulgin CO40 (ex BASF) | 3 | 9 | 9 | | | | | | |
| Neodol 91/8 (ex Shell) | 2.5 | | | | | | | | |
| Poly Suga Mulse D6 | | | | 4.5 | | | | | |
| (ex Colonial Chemicals) | | | | | | | | | |
| Poly Suga Mulse D9 | | | | 4.5 | | | | | |
| (ex Colonial Chemicals) | | | | | | | | | |
| Eumulgin VL 75 (ex BASF) | | | | | | | | | |
| Suspension agent | | | | | | | | | |
| Diutan Gum (ex Kelco) | | | | 0.2 | | 0.2 | 0.2 | | |
| Cellulon (ex Kelco, generic) | | 5 | 5 | | 5 | | | 5 | 5 |
| as supplied | | | | | | | | | |
| Cationic Deposition agent | | | | | | | | | |
| Flosoft FS 222 as supplied | 1.5 | | | | | | | | |
| (ex NSF) | | | | | | | | | |
| Jaguar C 500 | | 0.4 | 0.4 | 0.3 | 0.4 | | | | |
| Coltide (ex Croda) | | | | | | | | | 0.4 |
| Chitosan 200 000 g/mol | | | | | | 0.008 | | | |
| (ex Sigma Aldrich) | | | | | | | | | |
| Chitosan 1'700'000 g/mol | | | | | | | 0.008 | 0.008 | |
| (ex Sigma Aldrich) | | | | | | | | | |
| Choline chloride | | | | | | | | | |
| Electrolyte | | | | | | | | | |
| NaCl | | | | | | 1 | 1 | | |
| Microcapsules | | | | | | | | | |
| Dry microcapsules | 0.8 | 0.8 | 0.7 | 0.7 | 0.7 | 0.7 | 0.7 | 0.7 | 0.7 |
| Water | qsp | qsp | qsp | qsp | qsp | qsp | qsp | qsp | qsp |
| | 100 | 100 | 100 | 100 | 100 | 100 | 100 | 100 | 100 |
| Stable | Yes | Yes | Yes | Yes | Yes | Yes | Yes | Yes | Yes |

| Sample # | 10 | 11 | 12 | 13 | 14 | 15 | 16 | 17 | 18 | |
|---|---|---|---|---|---|---|---|---|---|---|
| Free perfume oil | 3 | 3 | 3 | 3 | 3 | 3 | 3 | 2 | 3 | 3 |
| Surfactant | | | | | | | | | | |
| Bio-sourced PEG-40- | 5 | | 5 | 5 | 5 | | | | | |
| hydrogenated castor oil | | | | | | | | | | |
| Eumulgin CO40 (ex BASF) | | | | | | 5 | | | | |
| Neodol 91/8 (ex Shell) | | | | | | | | | | |
| Poly Suga Mulse D6 | | | | | | | | | | |
| (ex Colonial Chemicals) | | | | | | | | | | |
| Poly Suga Mulse D9 | | 9 | | | | 4 | 9 | 6 | | |
| (ex Colonial Chemicals) | | | | | | | | | | |
| Eumulgin VL 75 (ex BASF) | | | | | | | | | 5 | 3.5 |
| Suspension agent | | | | | | | | | | |
| Diutan Gum (ex Kelco) | | 0.2 | | | | 0.1 | 0.2 | 0.3 | 0.2 | 0.3 |
| Cellulon (ex Kelco, generic) | 5 | | 5 | 5 | 5 | | | | | |
| as supplied | | | | | | | | | | |
| Cationic Deposition agent | | | | | | | | | | |
| Flosoft FS 222 as supplied | | | | | | | | | | |
| (ex NSF) | | | | | | | | | | |
| Jaguar C 500 | | | | | | | | | | |
| Coltide (ex Croda) | 0.8 | | | | 0.4 | 1 | | | | |
| Chitosan 200 000 g/mol | | | | | | | 0.008 | 0.003 | | |
| (ex Sigma Aldrich) | | | | | | | | | | |
| Chitosan 1'700'000 g/mol | | 0.006 | | | | | | | 0.006 | 0.0013 |
| (ex Sigma Aldrich) | | | | | | | | | | |
| Choline chloride | | 1 | 0.4 | 0.8 | 0.4 | | | | | |
| Electrolyte | | | | | | | | | | |
| NaCl | | | | | | | 1 | | 1 | 1 |
| Microcapsules | | | | | | | | | | |
| Dry microcapsules | 0.7 | 0.7 | 0.7 | 0.7 | 0.7 | 0.7 | 0.7 | 1.1 | 0.7 | 0.7 |
| Water | qsp | qsp | qsp | qsp | qsp | qsp | qsp | qsp | qsp | qsp |
| | 100 | 100 | 100 | 100 | 100 | 100 | 100 | 100 | 100 | 100 |
| Stable | Yes | Yes | Yes | Yes | Yes | Yes | Yes | Yes | Yes | Yes |

It can be observed that Poly Suga Mulse D6 and/or D9 (sorbitan oleate decylglucoside crosspolymer, Examples 4, 11, 16 and 17) can advantageously be used as bio-sourced surfactant alternatives to Neodol 91/8 and/or Eumulgin C040 (Examples 1-3 and 15). It can also be observed that bio-sourced PEG-40-hydrogenated castor oil (Examples 5-10 and 12-14) can be used as a bio-sourced alternative to Eumulgin C040 (Examples 2, 3 and 15), which is a synthetic poly(ethylene oxide) hydrogenated castor oil.

### Example 2—Olfactive Evaluation of Liquid Scent Boosters

20 g of a series of compositions obtained in Example 1 were added to the softener compartment of a European front-loaded wash machine, loaded with 850 g of cotton fabrics, consisting of a cotton towel, a 100% polyester T-shirt and a 95% cotton/5% lycra T-shirt. The wash cycle was completed during 50 minutes at 40° C., followed by spin drying at 1000 rpm.

For the olfactive evaluation, the terry toweling was handled carefully in order to minimize the risk of breaking the microcapsules mechanically. The odor intensity was assessed on the wet terry toweling just taken out of the washing machine, without breaking the microcapsules. The pre-rub and post-rub olfactive evaluation was performed after line drying the terry toweling for 24 hours at room temperature. The olfactive performance (intensity) was assessed by a panel of 4 experts rating on a scale of 1-5 (1=barely noticeable, 2=weak, 3=medium, 4=strong and 5=very strong). In such evaluation, the post-rub score measures the additional impact induced by microcapsule breakage, compared to the pre-rub intensity.

The results of the olfactive evaluation are reported in Table 2

TABLE 2
Olfactive evaluation scores (intensity)

| Sample # | 1 | 2 | 6 | 7 | 8 | 9 | 10 | 12 | 13 | 14 | 16 | 18 | 19 |
|---|---|---|---|---|---|---|---|---|---|---|---|---|---|
| Wet | 3.7 | 3.5 | 3.2 | 3.2 | 4.0 | 3.5 | 4.0 | 3.8 | 3.7 | 3.8 | 3.2 | 3.5 | 4.1 |
| Pre-rub | 2.6 | 2.0 | 1.7 | 2.2 | 3.0 | 2.5 | 3.0 | 2.8 | 2.3 | 2.8 | 1.8 | 2.4 | 3.0 |
| Post-rub | 2.5 | 2.5 | 2.3 | 2.8 | 3.5 | 2.0 | 2.3 | 2.5 | 2.7 | 2.8 | 2.6 | 2.3 | 3.5 |

As apparent from Table 2, all samples provide good olfactive results. Samples 7, 8, 12, 13, 14, 16 and 19 provide surprisingly high post-rub odor intensity, especially when compared with the non-bio sourced Sample 1 and the partly bio-sourced Sample 2.

The results show also that choline chloride, without any other deposition agent (samples 12 and 13), surprisingly enhances the olfactive performance of the composition, presumably by screening the negative charges of the microcapsules and increasing the deposition of the latter.

These results show that the fully bio-sourced compositions according to the inventions (samples 6, 7, 8, 12, 13, 14, 16, 18 and 19) offer equivalent or even better alternatives to non-bio sourced composition 1 and the partly bio-sourced composition 2.

### Example 3—Formulations of Liquid Fabric Refresher

The samples were prepared as described in Example 1, but omitting the cationic deposition agent and the electrolyte. The formulations are reported in Table 3.

TABLE 3
Liquid fabric refresher formulations

| Sample # | 20 | 21 | 22 | 23 | 24 | 25 |
|---|---|---|---|---|---|---|
| Free perfume oil | 1 | 1 | 1 | 1 | 1 | 1 |
| Surfactant | | | | | | |
| Bio-sourced PEG-40- | 3 | 3 | | | | |
| hydrogenated castor oil | | | | | | |
| Eumulgin CO40 (ex | | | 3 | | | |
| BASF) | | | | | | |
| Neodol 91/8 (ex Shell) | | | | 3 | | |
| Eumulgin VL 75 (ex | | | | | 4.0 | 4.0 |
| BASF) | | | | | | |
| Suspension agent | | | | | | |
| Diutan Gum (ex Kelco) | 0.15 | | | | 0.15 | |
| Cellulon (ex Kelco, | | 4 | | | | 4 |
| generic) | | | | | | |
| as supplied | | | | | | |
| Carbopol 980 (ex | | | 0.1 | 0.1 | | |
| Lubrizol) | | | | | | |
| Microcapsules | | | | | | |
| Dry microcapsules | 0.3 | 0.3 | 0.3 | 0.3 | 0.3 | 0.3 |
| Water | qsp | qsp | qsp | qsp | qsp | qsp |
| | 100 | 100 | 100 | 100 | 100 | 100 |
| Stable | Yes | Yes | Yes | Yes | Yes | Yes |

### Example 4—Olfactive Evaluations of Liquid Fabric Refresher

2 g of a series of compositions obtained in Example 3 were sprayed onto fabrics, consisting of a 100% cotton T-shirt, a 100% polyester T-shirt and a 95% cotton/5% lycra T-shirt.

For the olfactive evaluation, the fabrics were handled carefully in order to minimize the risk of breaking the microcapsules mechanically. The odor intensity was assessed 5 minutes after spraying without breaking the microcapsules. The pre-rub and post-rub olfactive evaluation was performed after line drying the T-shirts for 24 hours at room temperature. The olfactive performance (intensity) was assessed by a panel of 4 experts rating on a scale of 1-5 (1=barely noticeable, 2=weak, 3=medium, 4=strong and 5=very strong). In such evaluation, the post-rub score measures the additional impact induced by microcapsule breakage, compared to the pre-rub intensity.

The results of the olfactive evaluation are reported in Table 4

TABLE 4
Olfactive evaluation scores (intensity)

| Sample # | 20 | 21 | 22 | 23 | 24 | 25 |
|---|---|---|---|---|---|---|
| After spraying | 3.6 | 3.7 | 3.7 | 3.2 | 3.8 | 3.7 |
| Pre-rub | 2.1 | 2.0 | 2.1 | 1.8 | 2.2 | 2.1 |
| Post-rub | 2.6 | 2.5 | 2.5 | 2.2 | 2.7 | 2.6 |

As apparent from Table 4, all samples provide good olfactive results. Samples 20, 21, 24, and 25 provide surprisingly high post-rub odor intensity, especially when compared with the non-bio sourced Samples 22 and 23.

These results show that the fully bio-sourced compositions according to the inventions (samples 20, 21, 24, and 25) offer equivalent or even better alternatives to non-bio sourced composition 22 and 23.

1. A fabric care composition comprising:
a) at least one non-encapsulated perfume ingredient;
b) at least one core-shell microcapsule, wherein the at least one core-shell microcapsule comprises a core containing at least one encapsulated perfume ingredient and a shell surrounding the core;
c) at least one surfactant;
d) a suspending agent comprising at least one polysaccharide.

2. The composition according to claim 22, wherein at least 60 wt.-% of the ingredients a) to e) are biodegradable.

3. The composition according to claim 1, wherein at least 60 wt.-% of the at least one non-encapsulated fragrance ingredient and the at least one encapsulated fragrance ingredient are biodegradable.

4. The composition according to claim 1, wherein at least 60 wt.-% of the carbon atoms present in the composition are renewable.

5. The composition according to claim 23, wherein at least one of the ingredients c), d) or e) is bio-sourced.

6. The composition according claim 1, wherein the shell of the core-shell microcapsule comprises biodegradable polymers.

7. The composition according to claim 1, wherein the at least one surfactant is biodegradable.

8. The composition according to claim 1, wherein the at least one surfactant is selected from the group consisting of ethoxylated fatty acid triglycerides, alkyl alcohol ethoxylate, alkyl polyglycerides, glycolipids, sugar amide surfactants, polyglyceryl fatty acid esters, amino acid esters, amino acid amides, alkyl glucoside and alkyl polyglucosides, sorbitan fatty ester alkylglucoside crosspolymers, and combinations thereof.

9. The composition according to claim 1, wherein the at least one polysaccharide is selected from the group consisting of celluloses obtained from a fermentation process.

10. The composition according to claim 22, wherein the deposition agent is selected from the group consisting of cationic guar gums, proteins and chitosan.

11. The composition according to claim 23, wherein the electrolyte is selected from the group consisting of monovalent metal salts, choline chloride and combinations thereof.

12. The composition according to claim 1, comprising:
a) from 0.5 to 4 wt.-% of the at least one non-encapsulated perfume ingredient;
b) from 0.2 to 2 wt.-% of the at least one core-shell microcapsule;
c) from 2.5 to 12 wt.-% of the at least one surfactant;
d) from 0.05 to 6 wt.-% of suspending agent comprising at least one polysaccharide.

13. The composition according to claim 1, comprising:
a) from 0.5 to 4 wt.-% of at least one non-encapsulated perfume ingredient;
b) from 0.2 to 2 wt.-% of at least one core-shell microcapsule;
c) from 2.5 to 8 wt.-% of ethoxylated hydrogenated castor oil;
d) from 0.05 to 6 wt.-% of bacterial derived cellulose, diutan gum or combinations thereof;
f) from 0.0 to 2.5 wt.-% of an electrolyte.

14. (canceled)

15. The composition according to claim 1, comprising:
a) from 0.5 to 4 wt.-% of at least one non-encapsulated perfume ingredient;
b) from 0.2 to 2 wt.-% of at least one core-shell microcapsule;
c) from 4 to 12 wt.-% of sorbitan oleate decylglucoside crosspolymer having a HLB value of from 12 to 14;
d) from 0.05 to 1 wt.-% of diutan gum;
e) From 0.0005 to 0.1 wt-%, of chitosan, wherein the chitosan has a molecular weight between 3,000 and 1,000,000 g/mol; and
f) from 0.1 to 5 wt.-% of an electrolyte.

16. The composition according to claim 1, wherein the composition is a liquid scent booster or a fabric refresher.

17. A method of preparing the composition according to claim 1, comprising the step of emulsifying the at least one non-encapsulated fragrance ingredient and a composition comprising the at least one surfactant, the at least one suspending agent, the at least one microcapsule.

18. A method of enhancing fragrance perception on fabrics, the method comprising:
contacting the fabrics with the composition according to claim 1.

19. The method of claim 18, wherein the composition is added to the softener compartment of a laundry wash machine, and wherein the composition is a liquid scent booster.

20. The method according to claim 18, wherein the weight ratio of the composition to the fabric being contacted is from 0.001 to 0.1.

21. The method according to claim 18, wherein the composition is sprayed on laundry, and wherein the composition is a laundry refresher.

22. The composition according to claim 1, further comprising:
e) a cationic deposition agent.

23. The composition according to claim 1, further comprising:
f) an electrolyte.

24. The composition according to claim 12, comprising:
e) from 0.0005 to 2 wt-% of a cationic deposition agent.

25. The composition according to claim 12, comprising:
f) from 0.1 to 5 wt-% of an electrolyte.

26. The composition according to claim 13, comprising:
e) from 0.0005 to 0.1 wt-% of chitosan, wherein the chitosan has a molecular weight between 500,000 and 5,000,000 g/mol.

27. The composition according to claim 13, comprising:
e) from 0.2 to 2 wt-% of a protein.
